(19) United States
(12) Patent Application Publication
(10) Pub. No.: US 2007/0267972 A1
(43) Pub. Date: Nov. 22, 2007

(54) Method for forming a temporary hermetic seal for an OLED display device

(76) Inventors: Harry E. Menegus, Beaver Dams, NY (US); Kevin Robert McCarthy, Horseheads, NY (US); Holly Jean Strzepek, Bath, NY (US)

Correspondence Address: CORNING INCORPORATED, SP-TI-3-1, CORNING, NY, 14831, US

(21) Appl. No.: 11/726,420

(22) Filed: Mar. 22, 2007

Related U.S. Application Data
(60) Provisional application No. 60/802,835, filed on May 22, 2006.

(51) Int. Cl. H05B 33/04; H05B 33/10

(52) U.S. Cl. 313/512; 313/506; 445/25

(57) ABSTRACT

A method of forming a temporary hermetic seal for an OLED device. The method includes the steps of providing a first glass substrate having at least one OLED device disposed thereon, providing a second glass substrate having one or more frit walls disposed thereon, disposing sealant grease about a periphery of the first or second substrate and joining the first substrate to the second substrate to form an hermetically sealed glass envelop containing at least one OLED device.

This application claims the benefit of priority under 35 U.S.C. § 119(e) of U.S. Provisional Application Ser. No. 60/802,835 filed on May 22, 2006, the content of which is incorporated herein by reference.

### BACKGROUND OF THE INVENTION

1. Field of the Invention

The present invention relates to a method for inhibiting oxygen and moisture penetration, and subsequent degradation of a device and the resulting device. Examples of this device include a light-emitting device (e.g., organic emitting light diode (OLED) device), a photovoltaic device, a thin-film sensor, an evanescent waveguide sensor.

2. Technical Background

Organic light emitting diodes (OLEDs) may be used as optical displays for a variety of electronic devices. Such display applications include cell phone displays, personal data assistant (PDA) displays, camera displays and so forth. OLED-based devices comprise, inter alia, one or more OLEDs sandwiched between two substrates, such as glass substrates. The device also includes various power leads and electronic components, such as thin film transistors to control the OLEDs. Development of display devices sometimes requires transportation of the displays from one site to another prior to finally hermetically sealing the device. For example, a device may be assembled at one location, and transported to another location for final hermetic sealing of the device.

Unfortunately, transport of oxygen or water through laminated or encapsulated materials and subsequent attack of an inner material(s) represent two of the more common degradation mechanisms associated with many devices like for example light-emitting devices (OLED devices), thin-film sensors, and evanescent waveguide sensors.

It is therefore necessary at times to provide for a temporary hermetic seal between the two substrates during transportation to avoid degradation of a device deposited therebetween. Such a temporary seal should be capable of protecting the device from environmental exposure for moderate lengths of time (e.g. 10-14 days), under a variety of conditions, such as air transportation, where the display may be subjected to varying external pressure.

### SUMMARY

In one embodiment of the present invention, a method for forming a temporary hermetic seal for an OLED device is provided comprising providing a first glass substrate having at least one OLED device disposed thereon, providing a second glass substrate having one or more frit walls disposed thereon, disposing sealant grease about a periphery of the first or second substrate and joining the first substrate to the second substrate to form an hermetically sealed glass envelop containing the at least one OLED device.

In another embodiment of the present invention, a method of forming a glass envelope is disclosed comprising providing a first glass substrate having at least one OLED device disposed thereon, providing a second glass substrate having at least one frit wall disposed thereon, the at least one frit wall forming an enclosed frame, disposing sealant grease about a periphery of the first or second substrate, joining the first and second substrates such that the at least one OLED device is disposed within the frit wall and the sealant grease forms a first hermetic seal between the first and second substrates. After the substrates have been hermetically sealed with the sealant grease, the frit is heated to melt the frit an form a second hermetic seal between the first and second substrates. The sealant grease is then removed. The sealant grease may be removed, for example, by removing portions of the first and second substrates. Heating and melting of the frit may be accomplished, for example, using a laser.

In yet another embodiment a method for forming an hermetic seal about an OLED device comprising providing a glass envelope comprising first and second substrates and containing at least one OLED device disposed therein, the glass envelope comprising a frit wall and a sealant grease disposed between the first and second substrates, heating and melting the frit wall, thereby forming an hermetic frit seal between the first and second substrates, and removing the sealant grease.

In still another embodiment, a glass envelope is disclosed comprising a first glass substrate, a second glass substrate, at least one OLED device disposed between the first and second substrates and sealant grease disposed between the first and second substrates about a periphery of the substrates, thereby forming an hermetic seal between the first and second substrates.

The invention will be understood more easily and other objects, characteristics, details and advantages thereof will become more clearly apparent in the course of the following explanatory description, which is given, without in any way implying a limitation, with reference to the attached Figures. It is intended that all such additional systems, methods features and advantages be included within this description, be within the scope of the present invention, and be protected by the accompanying claims.

### BRIEF DESCRIPTION OF THE DRAWINGS

FIG. 1 is a cutaway view of an OLED device.

FIG. 2 is a top down view of a temporarily sealed envelope in accordance with an embodiment of the present invention comprising a plurality of OLED devices.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

For purposes of discussion and not limitation, the following description will be presented in terms of an OLED display device. The skilled artisan will appreciate that the techniques disclosed herein may be applicable to the temporary encapsulation of other devices where hermeticity over a pre-determined length of time is desired. Examples of other devices include a photovoltaic device, a thin-film sensor, or an evanescent waveguide sensor.

In an exemplary OLED display device manufacturing operation, at least one OLED device is deposited onto a first glass substrate. The at least one OLED device comprises a cathode, one or more layers of an organic, light emitting material, and an anode. A second glass substrate is then placed overtop the first glass substrate. The second glass substrate includes a line of glass frit deposited on the second substrate in a closed, frame-like pattern about a periphery of the substrate, forming a wall. The frit wall is disposed between the first and second substrates, thereby forming a glass envelope between the two substrates, with the at least one OLED device disposed therein. The first and second substrates may thereafter be sealed by heating the frit with a laser beam. Such laser sealing techniques are known in the art and will not be described further so as not to obscure the present invention. However, in brief, a laser beam having a suitable wavelength whereby energy from the laser beam is absorbed by the frit is traversed over the frit wall (typically through one or both of the substrates), thereby heating and melting the frit to join the first and second substrates.

A plurality of OLED devices may be formed using the first and second substrates. For example, a plurality of frit walls may be formed on one substrate in an m×n matrix, while a plurality of OLED devices may be formed on the second substrate. The first and second substrates may then be joined by heating the frit frames, such as with a laser, until an hermetic seal in formed around each OLED device.

In certain circumstances, it may be desirable to join the first and second substrates temporarily. For example, assembly of the substrates and one or more display devices may occur at one facility, while the heating and sealing of the frit may occur at a second facility distant from the first facility. The distance between the assembly facility and the frit sealing facility can be on the order of several miles, to many thousands of miles. Transportation of the assemblies from the assembly facility to the frit sealing facility can include air transport, meaning significant pressure changes can occur in the surrounding environment.

In accordance with an embodiment of the present invention, a temporary hermetic seal between the first and second substrates can be formed by depositing sealant grease between the first and second substrates, about a periphery of the substrates. By periphery what is meant is that the sealant grease is deposited in close proximity to, but inward of, the edges of the glass substrate. The first and second substrates may later be frit sealed, and the temporary grease seal removed by cutting away the portions of the first and second substrates having the sealing grease disposed thereon.

Suitable sealing greases include readily available commercial vacuum greases such as, for example, Dow-Corning High Vacuum Grease 15 V 2645 Stopcock/Vacuum Grease, Dow Corning 976V High Vacuum Grease, Santovac 5 GB Ultra High Vacuum Grease, Braycote 600EF High Vacuum Grease, and Apiezon M High Vacuum Grease as a sealant. In the alternative, ordinary dental fixative, for use with dentures, such as Polygrip brand dental fixative, has been found to be effective, and considerably less expensive than commercially available vacuum greases. Other materials suitable for forming a temporary hermetic seal include a UV curable acrylate, high modulus monomers (e.g. DSM 950-111 or DC Q3-6696), UV curable cationic epoxy adhesives (e.g. Loctite 3337), and UV curable acrylates. As used herein, the term sealant grease is intended to encompass any of the above materials, combinations thereof, or similar materials which may serve to form a temporary hermetic seal.

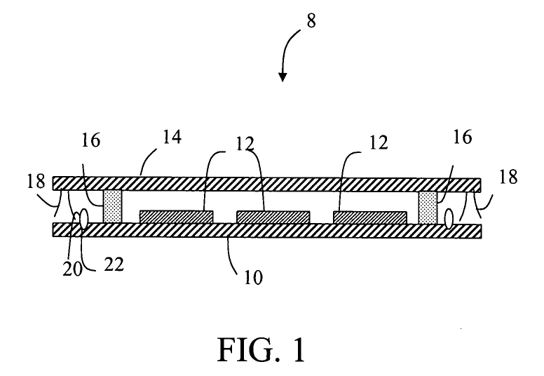

As shown in FIG. 1, according to the present embodiment, an OLED display assembly 8 comprising a first (back plane) substrate 10 having at least one OLED device 12 is provided. Preferably, the back plane substrate is a thin glass sheet having a thickness of less than about 1 mm, preferably less than about 0.7 mm. A second (cover) substrate 14 is also provided. Preferably, cover plane substrate 14 (or simply cover substrate 14) is a thin glass sheet having a thickness of less than about 1 mm, preferably less than about 0.7 mm. Cover substrate 14 also has at least one frit wall 16 disposed thereon, the frit wall in the shape of a closed frame, thereby forming a well bounded by the frit wall on cover substrate 14. The frit wall has a height typically on the order of 10-15 μm above the surface of the cover substrate on which the frit is deposited. A bead of sealant grease 18 is dispensed about a periphery of cover substrate 14, outside of the frit wall, preferably a distance from the frit wall. Back plane substrate 10 and cover substrate 14 are then brought together (joined) under a substantially uniform pressure such that vacuum grease 18 forms a contiguous and hermetic seal between the first and second substrates. After the temporarily hermetically sealed assembly is finally frit sealed, the portions of the assembly containing the vacuum grease may be cut away. Cutting away the vacuum grease may be accomplished, for example, by known methods, such as by “score and snap”, whereby the glass substrates are first scored, after which a bending moment is applied to separate the glass substrates along the score line. Laser scoring and/or cutting as is conventionally known may also be performed.

Several steps may be taken to improve the hermeticity of the seal. For example, it has been found that a more uniform bead of vacuum grease may be obtained by employing an automated dispensing apparatus, such as a pneumatic syringe. Also, assembly within a glove box is preferred over assembly in open air, to minimize exposure to the ambient environment. Preferably, the glove box has a negative internal pressure relative to the ambient pressure. A dry, inert atmosphere within the glove box may be employed to prevent initial contamination of the OLED device(s).

Increased longevity of the temporarily hermetically sealed OLED device may be obtained by including a desiccant 20 within the envelope formed between the first and second substrates, but is not required. For example, a desiccant may be included between the first and second substrates inside (interior to) the vacuum grease seal, but outside (exterior to) the frit wall. When the vacuum seal portion of the assembly is cut away, the desiccant is also removed. For example, a channel (22) may be formed in one or both of the substrates, and the channel filled with a desiccant. Also, the temporarily sealed assembly may be further vacuum sealed in a polymer bag (not shown) for transport. For example, an ordinary food sealing system may be used to seal the assembly in a polymer bag.

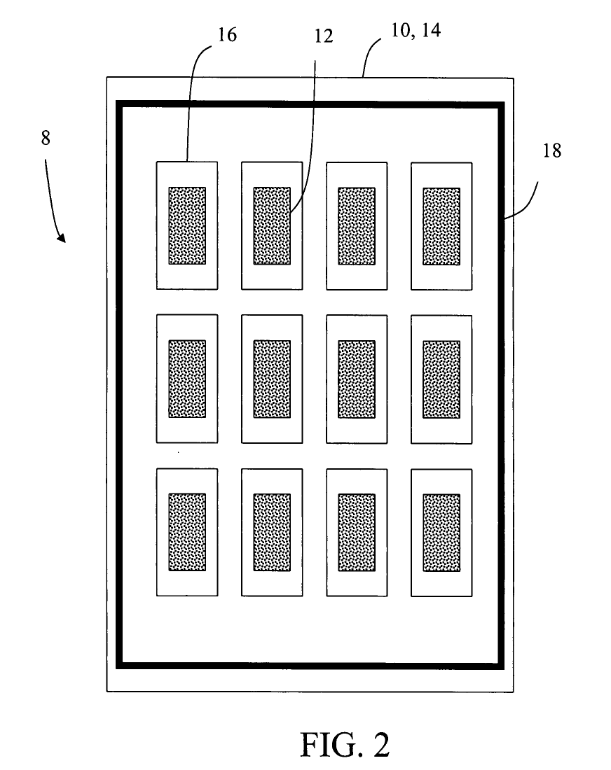

In some embodiments, as shown in FIG. 2, a plurality of OLED devices may be arranged between the first and second substrates. The OLED devices may be arranged on back plane substrate 10 in an m×n matrix. Similarly, frit walls 16 are also arranged in an m×n matrix such that when first and second substrates 10, 14 are sealed, each OLED device 12 resides within each frit wall 16. A temporary hermetic seal is then formed in accordance with the previous description between and about the periphery of the first and second substrates, sealing in the m×n matrix of OLED devices.

It has been found that temporary hermetic seals of the type described above can maintain their hermeticity in excess of at least about 300 hours, and in some instances, 800 hours. For most applications contemplated herein, this has been found to be satisfactory.

### EXAMPLE 1

A first and second glass cover substrate was provided. Each substrate was about 0.7 mm in thickness and 6 inch (15.24 cm) square. Each of the glass cover substrates included frit frames disposed thereon in an m×n pattern.

First and second back plane substrates were also provided having dimensions the same as the cover substrates. To represent individual OLED display devices and to provide a visual confirmation of hermeticity, calcium metal films were deposited in an m×n matrix on the surface of each back plane substrate. If exposed to air, the calcium metal film transforms from having a silvery surface to being milky in appearance. The thickness of the calcium films on the first substrate were approximately 600 nm, while the thickness of the calcium films on the second substrate were approximately 700 nm.

A vacuum grease (Dow-Corning High Vacuum Grease (15 V 2645 Stopcock/Vacuum Grease, 150 g. Tube) was dispensed with a syringe around the perimeter of each cover substrate, creating a grease bead. The first sample had a thinner bead, while the other sample had a slightly thicker bead of the vacuum grease.

The sample substrates were stored in a glove box having an argon atmosphere during preparation. A single cover substrate and a single back plane substrate were then removed from the glove box and the cover glass substrate was quickly placed on top of the back plane substrates, using manual alignment, such that each calcium film on the back plane substrate was contained within each frit frame of the cover substrate. Uniform pressure was applied to the assembly using a steel plate to create a temporary seal. The above procedure was repeated for the second set of cover and back plane substrates. The 600 nm calcium sample substrate was assembled with the thinner bead of vacuum grease while the 700 nm calcium sample substrate was assembled with the thicker bead of vacuum grease. Initial observations showed a seal width ranging between about 4 mm to 8 mm. On each sample, there were narrow sections as thin as about 1 to 2 mm, and there appeared to be some air entrapment in the start stop positions of the grease deposition.

After approximately 48 hours, the 700 nm calcium assembly showed slight degradation, most likely attributed to the non-uniformity in the manual application of the vacuum grease bead. The 600 nm calcium assembly still indicated as good hermetic seal.

### EXAMPLE 2

A second experiment was conducted similar to that described in Example 1 above. Six assemblies were constructed. Two assemblies were constructed using Santovac 5 GB Ultra High Vacuum Grease as a sealant, two assemblies were constructed using Braycote 600EF High Vacuum Grease as a sealant, and two assemblies were constructed using Apiezon M High Vacuum Grease as a sealant. The sealant in all cases was dispensed using an air-powered syringe application tips and adapters from the EFD® company. One calcium film (emulating an OLED device) on a single Bracote assembly failed after 337 hours, a second “device” failed after 33381 hours, and a third device failed after 522 hours. All other samples exceeded 882 hours of hermeticity.

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method for hermetically sealing an OLED device comprising:
providing a first glass substrate having at least one OLED device disposed thereon;
providing a second glass substrate having at least one frit wall disposed thereon;
disposing a sealant grease about a periphery of the first or second substrate; and
joining the first substrate to the second substrate such that the sealant grease encircles the at least one frit wall and forms an hermetically sealed glass envelope containing the at least one OLED device.

2. The method according to claim 2 further comprising prior to the joining disposing a desiccant between the sealant grease and the frit wall.

3. The method according to claim 3 wherein the desiccant is disposed within a channel formed in the first or second substrate.

4. The method according to claim 1 wherein the glass envelope is sealed within a polymer bag subsequent to the joining.

5. The method according to claim 1 further comprising heating and melting the frit to form a frit seal between the first and second substrates.

6. The method according to claim 5 further comprising removing the sealant grease after the heating.

7. The method according to claim 6 wherein the sealant grease is removed by cutting away portions of the first and second substrates.

8. A method for forming a glass envelope comprising:
providing a first glass substrate having at least one OLED device disposed thereon;
providing a second glass substrate having at least one frit wall disposed thereon, the at least one frit wall forming an enclosed frame;
disposing sealant grease about a periphery of the first or second substrate;
joining the first and second substrates such that the at least one OLED device is disposed within the frit wall and the sealant grease forms a first hermetic seal between the first and second substrates;
heating the frit to form a second hermetic seal between the first and second substrates; and
removing the sealant grease.

9. The method according to claim 8 wherein the sealant grease is removed by cutting away portions of the first and second substrates.

10. The method according to claim 8 wherein the heating is performed with a laser.

11. A method for forming an hermetic seal about an OLED device comprising:
providing a glass envelope comprising first and second substrates and containing at least one OLED device disposed therein, the glass envelope comprising a frit wall and sealant grease disposed between the first and second substrates;
heating and melting the frit wall, thereby forming an hermetic frit seal between the first and second substrates; and
removing the sealant grease.

12. The method according to claim 11 wherein the sealant grease is removed by removing portions of the first and second substrates.

13. The method according to claim 11 wherein the heating is performed with a laser.

14. A glass envelope comprising:
a first glass substrate;
a second glass substrate;
at least one OLED device disposed between the first and second substrates; and
sealant grease disposed between the first and second substrates, thereby forming an hermetic seal between the first and second substrates.

15. The glass envelope according to claim 14 further comprising a frit wall spaced inward from the sealant grease.

16. The glass envelope according to claim 15 wherein a gap is disposed between the sealant grease and the frit wall.

17. The glass envelope according to claim 16 further comprising a desiccant disposed in the gap.
